(19) United States
(12) Patent Application Publication
(10) Pub. No.: US 2010/0287944 A1
(43) Pub. Date: Nov. 18, 2010

(54) AVAILABILITY IMPROVEMENTS TO HEAVY FUEL FIRED GAS TURBINES

(75) Inventors: Sam David Draper, Simpsonville, SC (US); David August Snider, Simpsonville, SC (US); Robert Thomas Thatcher, Greer, SC (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 12/767,134

(22) Filed: Apr. 26, 2010

Related U.S. Application Data
(60) Provisional application No. 61/178,013, filed on May 13, 2009.

(51) Int. Cl. F02C 9/00

(52) U.S. Cl. 60/772

(57) ABSTRACT

Maintenance operations for a hot gas path of a gas turbine require shutdown and cooled down conditions. When a gas turbine is shut down, thermal gradients in the rotor cause stresses that limit the life of the major components. As the cooling rate is increased to reduce the time, the stresses are increased, reducing rotor life. A method and equipment are provided to reduce the overall cycle time for the maintenance, yet mitigate the life penalties, thereby providing greater power production while maintaining (or potentially extending) rotor life. The method includes small hold times during the turbine shutdown and startup and slower turbine ramp rates during cooldown and startup, which more than offset thermal stresses from a forced cooldown, considerably shortening the overall operation.

### CROSS REFERENCE TO RELATED APPLICATIONS

This application is related and draws priority to U.S. Provisional Patent Application Ser. No. 61/178,013 entitled “AVAILABILITY IMPROVEMENTS TO HEAVY FUEL FIRED GAS TURBINES”, filed on May 13, 2009 and assigned to General Electric Co, which is herein incorporated by reference.

### BACKGROUND OF THE INVENTION

The invention relates generally to gas turbines and more specifically to a method and equipment for performing expedited gas turbine outages.

The economy of gas turbine operation dictates that gas turbines be available to produce power to the maximum extent possible. However, it is known that planned and unplanned outages for gas turbine preventive maintenance and repair are required over the life of the equipment. It is advantageous to be able to expeditiously shutdown the gas turbine, establish the conditions required to perform the maintenance, and then return to operation quickly after the maintenance is complete. One example of an operation requiring a shutdown, cooldown, startup and heatup of a gas turbine is a turbine water wash of a hot gas path.

In order to burn heavy fuels (crude and residual oil) turbine washes are required. These washes occur every 3 to 17 days depending on the composition of the fuel and other operating and environmental conditions. The traditional wash cycle provides for injection of a wash solution into a combustor and through the hot gas path of the gas turbine. The wash cycle includes a wash, a soak, a rinse, a drain and a dry operation. The wash cycle may last about 1-2 hours. However, the total time conventionally required to shutdown and cooldown the gas turbine, perform the wash cycle, and then return the gas turbine to base load may take up to about 45 hours. In large part, the overall length from shutdown of the gas turbine to a return to base load is limited by allowing a non-forced cooldown to about 150 degrees F. in order to avoid thermal stresses and reduced life for the turbine rotor, the compressor rotor and the casings.

It is extremely costly for the power plant operator to have gas turbines out of service for the turbine wash cycle about 45 hours every 3 to 17 days Further, the operation of the wash cycle requires significant manpower over an extended period of time to support the wash cycle operation and the gas turbine transitioning. These personnel are not normally on duty around the clock.

Accordingly, it is desirable to provide a method and equipment for reducing the outage time for gas turbine operations of shutting down, cooling down, starting up and returning to service, while at the same time limiting thermal stresses on gas turbine components and preventing excessive fatigue or damage to components from transients.

### BRIEF DESCRIPTION OF THE INVENTION

Briefly in accordance with one aspect of the present invention, a method is provided for performing a maintenance operation for a hot gas path of a gas turbine. The method includes holding the turbine at full speed-no load conditions for a time during a shutdown. The method also includes controlling acceleration of the turbine to a first cooldown speed and a second cooldown speed during a forced cooldown to a temperature suitable for conducting the maintenance. Rotating the gas turbine rotor at these speeds forces air through the gas turbine which cools the gas turbine faster than the non-forced cooldown baseline. The method performs a partial turbine cooldown at a first cooldown speed and completes the turbine cooldown at a second cooldown speed, where the second cooldown speed is greater than the first cooldown speed. When turbine conditions are set, then the maintenance operation is performed. The method also includes ramping turbine speed at a reduced rate during the startup acceleration from light-off to full speed no load, and holding the turbine at full speed-no load conditions for a time prior to loading the turbine.

According to a second aspect of the present invention, a method is provided for performing an outage of a gas turbine including a compressor and a turbine to a cooled down condition for a maintenance operation. The method includes holding the gas turbine at full speed-no load conditions for a time during a shutdown. The method provides for controlling acceleration of the gas turbine to a first cooldown speed and a second cooldown speed during a forced cooldown to a temperature suitable for conducting a wash operation of the hot gas path. A partial turbine cooldown is performed at a first cooldown speed. The turbine cooldown is completed at a second cooldown speed, where the second cooldown speed is greater than the first cooldown speed.

A third aspect of the present invention provides a method for restoring from an outage of a gas turbine, including a compressor and a turbine, from a cooled down condition for maintenance. The method includes ramping gas turbine speed at a reduced rate during the startup acceleration from light-off to full speed no load and then holding the gas turbine at full speed-no load conditions for a time prior to loading the turbine.

### BRIEF DESCRIPTION OF THE DRAWING

These and other features, aspects, and advantages of the present invention will become better understood when the following detailed description is read with reference to the accompanying drawings in which like characters represent like parts throughout the drawings, wherein:

FIG. 1 illustrates a baseline turbine wash cycle using a conventional method;

FIG. 2 illustrates a sequence of operations for an embodiment of an inventive method for a gas turbine cooldown and return to loaded operation of the gas turbine;

FIG. 3 illustrates a flow chart for a method of performing an outage of a gas turbine including a compressor and a turbine, where a hot gas path for the gas turbine is cooled down to a maintenance condition, the maintenance is performed, and the gas turbine is restored to operation;

FIG. 4 illustrates a flow chart for a method for performing an outage of a gas turbine including a compressor and a turbine to a cooled down condition for a maintenance operation;

FIG. 5 illustrates a flow chart for a method for returning to operation from a cooled down condition following an outage; and

FIG. 6 illustrates a rotation scheme for a non-operating gas turbine with a starter motor and a torque converter.

### DETAILED DESCRIPTION OF THE INVENTION

The following embodiments of the present invention have many advantages, including significantly reducing current outage time for power gas turbines during operations that require a shutdown and cooldown and subsequent startup and heatup of a gas turbine or individual parts thereof. A method is provided to decrease the duration of the outages, including forced cooling of the system that was heretofore avoided. Critical to this system working is maintaining the life of the compressor and turbine rotor, casings, starting means, and exhaust system. In order to achieve this, a method has been provided to extend the duration of the startup and shutdown, and extend the motor ramp rate during the acceleration to the speed of forced cooling, but which safely permits a forced cooldown, so as to significantly reduce the overall time for the outage. Control of speed for the unloaded gas turbine is provided through new use of a starter motor and torque converter of the gas turbine.

One example of such an outage is a water washing operation of the hot gas path for the gas turbine. Other examples include water washing of the compressor, inspection and maintenance of the combustion hardware, inspection and maintenance of the hot gas path hardware, and inspection and maintenance of the total system.

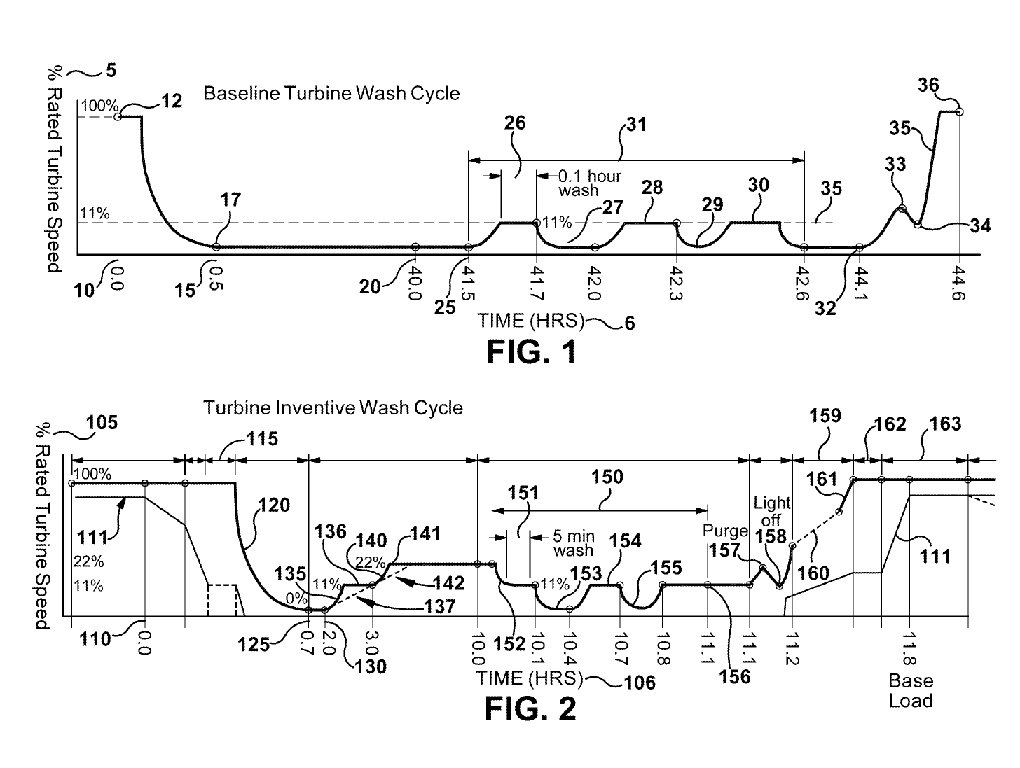

FIG. 1 provides a graph illustrating a conventional method for performing a turbine wash cycle from an operating condition at baseload through a return to baseload operation. The graph plots percent of rated turbine speed (5) versus time (6). The overall conventional operation takes about 45 hours. At time 0 (10), a shut down of the gas turbine from full operating speed is ordered . At about 0.5 hours (15), the turbine has reached ratchet speed wherein it is rotated periodically by a ratcheting device. Over the next 39 hours, the turbine cools down in an unforced manner due to losses to ambient. At time of about 40 hours (20), the turbine has cooled to about 150 degrees F. (a temperature considered acceptable for performing the wash) as measured by temperature measurement devices installed in the gas turbine. The length of time for cooldown is influenced by the ambient temperature, which may be especially high in certain geographic areas and therefore adversely influence the ambient cooldown rate.

At about 41.5 hours (25), a set of valves in the gas turbine system are manually positioned to set up the turbine for the water wash through the combustor and the hot gas path. The steps of wash (26), soak (27), rinse (28), drain (29) and a dry (30) of the overall wash operation (31) take only about 1 hour. During the wash (26) and dry (30), the gas turbine is rotated at about 11% of full speed (35). The rotating mechanism is the starter motor and torque converter. When the wash operation (31) is completed, the manual valves are then repositioned at about 44.1 hours (32) (from the wash operation position to a lineup for turbine operation). The turbine is purged of potential combustion elements (33), lighted-off (34) and the rotor is accelerated to full speed no load (35) and then the turbine is loaded to base load (36) at about 44.6 hours.

Of the total operational time from base load to base load, only about 1 hour involves the wash operation itself. Almost 40 hours are occupied in cooling down the turbine to a temperature acceptable for the wash operation. The slow cooldown to about 150 degrees F. for the wash operation has been traditionally performed to minimize stresses in the compressor and turbine rotors and other components that could potentially cause damage and shorten the life of these components.

FIG. 2 illustrates an embodiment of an inventive method for a gas turbine shutdown, cooldown and return to operation. The method is employed for performing a turbine wash cycle from an operating condition at baseload through a return to baseload operation. It should be understood that the method may be more broadly employed for a variety of operations necessitating cooldowns to maintenance conditions and restoration to turbine operation. It should also be understood that parts of the method may be employed without performance of the full method.

The graph of FIG. 2 plots turbine speed (105) versus time (106) during the operations of the inventive method. The overall operation may take about 12 hours, an improvement of about 33 hours over the prior art procedure.

At time 0 (110), a shut down of the gas turbine from full operating speed is ordered. A conventional unloading is initiated but a hold (115) of about 10 minutes is performed at full speed-no load (FSNL). A plot of firing temperature (111) is shown. After the FSNL hold (115), a conventional deceleration (120) is conducted until ratchet speed (125) is reached in about 0.7 hours. At ratchet speed, the turbine it is rotated periodically by a ratcheting device.

At about 2.0 hours (130), a smart cooldown is initiated. In a smart cooldown, the turbine is operated by a starter motor through a torque converter forcing ambient air to flow into the compressor inlet, through the combustor and through the hot gas path. The flow of ambient air through the turbine results in accelerated cooldown. Turbine speed is ramped (135) to about 11% speed (136), continuing cooling at that speed for about 1 hour. At about 3 hours, a second speed ramp (140) to about 22% speed is performed, continuing cooling at 22% speed (141) for about 7 hours until turbine wheelspace temperature is satisfactory for the wash operation. Faster speed intakes more cooling air and increases cooling rate. For the water wash operation, the cooldown is carried out to about 150 F. However, the method may be performed to establish other temperatures suitable for different operations.

The turbine wash operation (150) is performed at about 10.0 hours after positioning valves to set up the turbine for the water wash flow path through the combustor and the hot gas path. The smart cooldown saves about 30 hours over the prior art cooldown method. According to a further aspect of the present invention, the valves may be remotely operated valves. Further, the sequencing of valve operation may be initiated remotely from a control panel or according to an automatic sequence from a controller, such as but not limited to a turbine control system.

The wash (151) may be performed as the turbine ramps (152) from 22% speed to 11% speed. The rinse (153), drain (154), and dry (155) may be performed at about 11% speed. When the wash operation (150) is completed, the valve lineup for normal gas turbine startup may be restored according to an automated sequence.

At about 11.1 hours, the turbine may be prepared (156) for return to operation. The turbine is first purged (157) of potential combustion elements. At about 11.2 hours, the turbine is lighted off (158). The turbine is then accelerated to full speed no load by the use of a smart speed ramp. (159). The smart speed ramp (159) includes a reduced ramp rate (160) between about 35% speed and 55% speed for compressor stress margin, followed by a conventional ramp rate (161) to FSNL operation. Once at FSNL, a FSNL hold (162) of about 10 minutes may be performed for turbine stress margin. Following the FSNL hold (162), conventional loading (163) of the turbine may be performed. Firing temperature 111 is shown for the startup.

The forced cool down will reduce the time required to reach the required wheel space temperature for the specific maintenance operation (such as less than 150 F for hot gas path washing). The reduced cooldown time comes with the penalty of increased stresses and reduced life on the turbine and compressor rotor, and in the casings. The stresses in the rotor during the forced cool down are tensile. In order to offset the stresses of the forced cool-down and recover the life of the rotor, the start-up and shut-down of the engine are extended slightly in length. The forced cool down reduces the total time for the turbine wash cycle by up to 30 hours. Increasing the time of the startup and shutdown by as little as 10 minutes each will more than offset the stresses of forced cool down. A key inventive aspect is the overall combination of faster cool down with slower startup and shutdown resulting in a net increase in life of the rotor and casings.

During a shutdown of the gas turbine, the stresses begin to rise during the unload part of the unit shutdown. This is due to cooling of the rotor rim while the bores of the rotors stay hot. The compressor rotor has peak stress after FSNL, during the slow down. The turbine rotor has its peak stress at FSNL. For some gas turbines, the life of the compressor rotor is lower than the life of the turbine rotor. A hold during shutdown at FSNL will cause a reduction in life of the turbine rotor, but an increase in life of the compressor rotor. Analysis may be performed for each specific turbine application to calculate the ideal time to hold at FSNL to relieve the stresses, and increase the life of the compressor rotor, while not significantly increasing the damage to the turbine rotor, thereby balancing the system for a net increase in life.

Units in the field today execute forced cool downs. These forced cool downs induce additional stresses in the rotor, reducing life. Some units in the field wait 2 hours after shutdown before beginning the forced cool down. Re-acceleration of the rotor causes the rotor rim temperature to cool rapidly compared to the bore. As the thermal wave passes thru the rotor from the rim to the bore, a “shock” thermal gradient is created. That “shock” thermal gradient creates the high stresses in the rotor, casings, exhaust system, and creates clearances issues.

By dividing the acceleration of the turbine rotor during a forced cooldown into two steps, the thermal “shock” can be reduced, allowing the rotor rim to cool slowly, and allowing the thermal wave to pass to the bore. In a smart cooldown, the speed of the rotor is controlled such that the rate of cooldown is limited, thereby limiting the peak temperature gradient between the bulk of the rotor wheel and the rim of the rotor wheel, thereby limiting stress in the gas turbine rotor.

A startup of the engine induces compressive stresses in the compressor rotor. Reducing the compressive stresses during startup reduces the total strain range throughout the cycle, significantly increasing life. The design details of the compressor create a condition where certain stages of the compressor will benefit from a hold at FSNL during the start up, but other stages, stages, may only benefit from a slower ramp rate during the acceleration to FSNL. The acceleration must not include a hold at an intermediate speed, and the slowed acceleration segment must be late enough in the acceleration to have sufficient temperature, and early enough to avoid a rotating stall. Therefore, a slowed acceleration may be provided in the 30% to 55% speed range through a combination of starter motor control through the torque converter and fuel scheduling of the turbine. Limiting the rate of acceleration during a smart speed ramp reduces the heatup rate of the rim temperature of the limiting compressor wheel, thereby reducing the peak temperature differential between the rim and the bulk. Consequently, peak stress on the limiting compressor wheel is reduced. The slowed ramp rate with speed in the range of 30% to 55% will reduce peak stress when FSNL is reached by a significant amount.

A further aspect of the present inventive procedure is a hold at full speed-no load while returning a gas turbine to service during an inventive outage. The limiting component at the point of loading the gas turbine is a compressor wheel. A five-minute hold at FSNL before loading the gas turbine will reduce the temperature differential between the bulk of the compressor wheel and the rim. By reducing this temperature differential the peak stress, which occurs during the load ramp, the peak stress may be reduced to a significant degree.

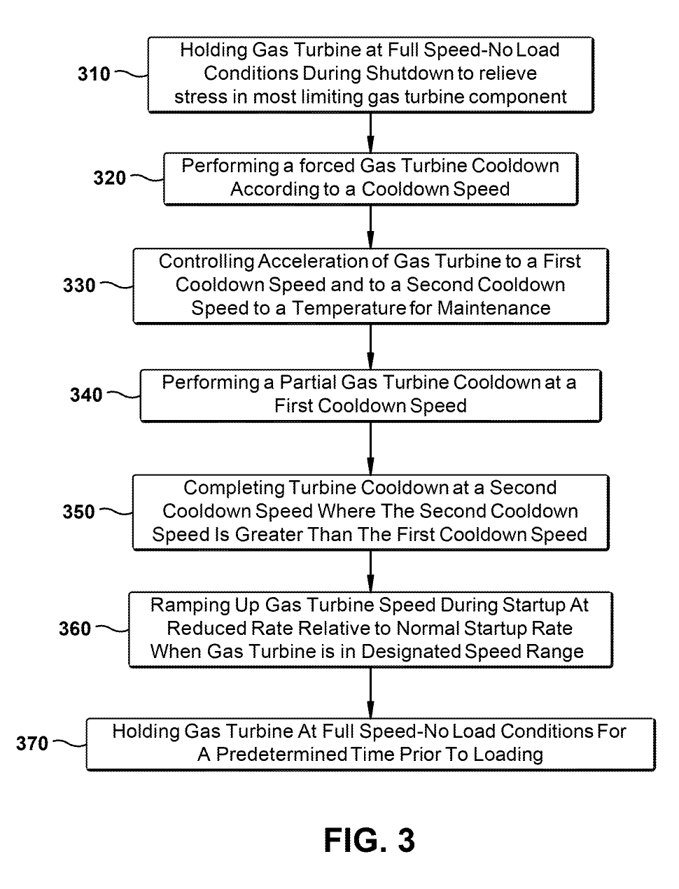

FIG. 3 illustrates a flow chart for a method of performing an outage of a gas turbine including a compressor and a turbine, where a hot gas path for the gas turbine is cooled down to a maintenance condition and restored to operation. In Step (310) holds the gas turbine at full speed-no load (FSNL) conditions during a shutdown to relieve thermal stresses in a most limiting component of the gas turbine at FSNL conditions. The gas turbine is held at the FSNL conditions for a designated time period. In Step (320), a forced cooldown rate is set by circulating ambient air through the hot gas path of the gas turbine according to a speed of the gas turbine. Step (330) controls acceleration of the gas turbine to a first cooldown speed and a second cooldown speed during the forced cooldown to a temperature suitable for conducting a maintenance operation. In Step (340) a partial turbine cooldown is performed at the first cooldown speed. In Step (350), the gas turbine cooldown is performed at a second cooldown speed, where the second cooldown speed is greater than the first cooldown speed. In Step (360), gas turbine speed is ramped up during a startup at a reduced rate relative to a normal ramp rate during startup when speed is in a designated range below FSNL. The gas turbine is held at FSNL conditions for a designated time prior to loading according to Step (370).

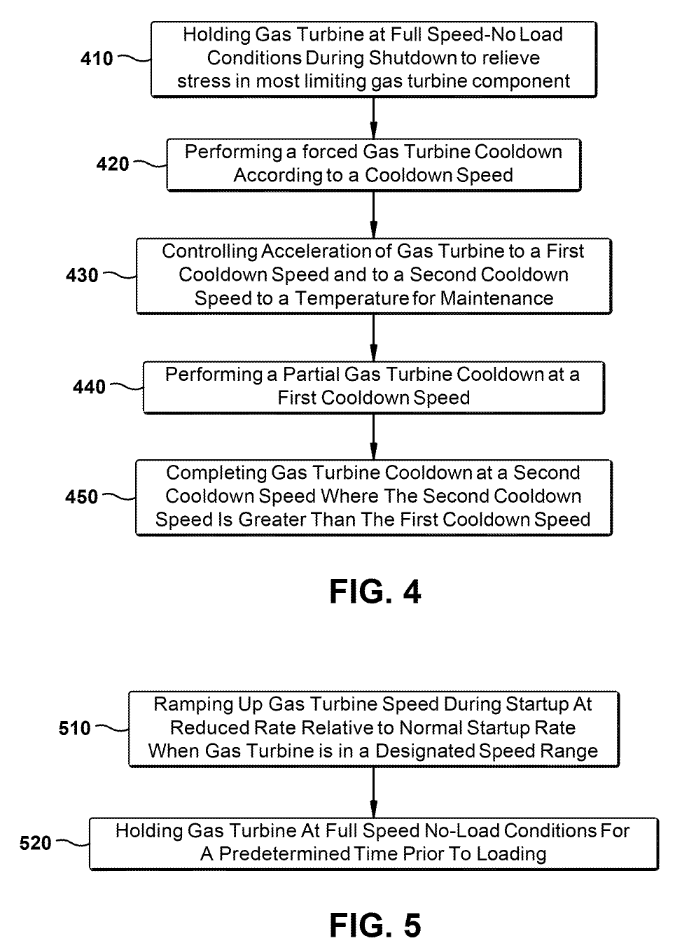

FIG. 4 illustrates a flow chart for a method for performing an outage of a gas turbine including a compressor and a turbine to a cooled down condition for a maintenance operation. Step (410) holds the gas turbine at full speed-no load (FSNL) conditions during a shutdown to relieve thermal stresses in a most limiting component of the gas turbine at FSNL conditions. The gas turbine is held at the FSNL conditions for a designated time period. In Step (420), a forced cooldown is performed by circulating ambient air through the hot gas path of the gas turbine according to a speed of the gas turbine. Step (430) controls acceleration of the gas turbine to a first cooldown speed and a second cooldown speed during the forced cooldown to a temperature suitable for conducting a maintenance operation. In Step (440) a partial turbine cooldown is performed at the first cooldown speed. In Step (450), the gas turbine cooldown is performed at a second cooldown speed, where the second cooldown speed is greater than the first cooldown speed, cooling the gas turbine to the required temperature condition for the maintenance operation.

FIG. 5 illustrates a flow chart for a method for returning to operation from a cooled down condition following an outage. In Step (510), gas turbine speed is ramped up during a startup at a reduced rate relative to a normal ramp rate during startup when speed is in a designated range below FSNL. The gas turbine is held at FSNL conditions for a designated time prior to loading according to Step (520).

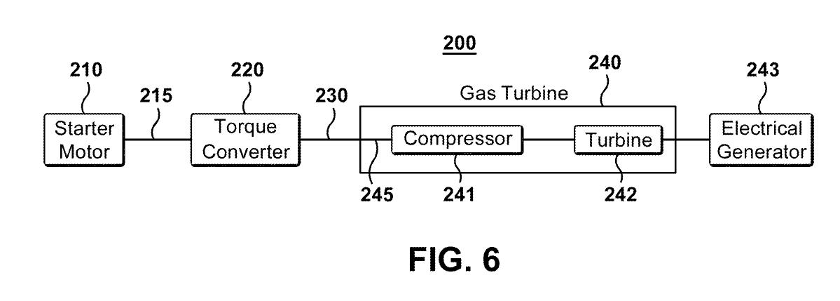

FIG. 6 illustrates a speed control arrangement (200) for a non-operating gas turbine with a starter motor and a torque converter. The starter motor (210) through the torque converter (220) may drive the shaft (245) of the unloaded gas turbine (240). The gas turbine (240) may include a compressor section (241) and a turbine section (242). The starter motor (210) is tied to an input side of the torque converter (220) through an input shaft (215). The torque converter (220) is tied to the gas turbine (240) through an output shaft (230). The starter motor (210) may be a constant speed motor (3600 rpm for 60 Hz or 3000 rpm for 50 Hz operation). An on-off control (not shown) may be provided for the motor with over-temperature protection. A method is provided for using the torque converter powered by the starter motor to slow the acceleration of the gas turbine rotor, thereby limiting heatup or cooldown rates, which otherwise would cause excessive peak stresses on limiting components.

The above embodiments provide several aspects advantageous to the operation of the gas turbine. The first aspect includes shortening the entire water wash cycle while increasing the duration of the start and shutdown to improve rotor life. The wash cycle is reduced from about 45 hours to less than 12 hours. A second aspect involves adding a full speed no load (FSNL) hold on shutdown to allow the rotor temperatures to equilibrate. A third aspect incorporates a full speed no load (FSNL) hold on startup to relieve stresses in the middle of the rotor, and slowing the speed ramp rate between 30% and 55% speed to relieve stresses in the aft end of the compressor rotor. A further aspect adds additional speed points between zero speed (ratchet) after shutdown, and 22% speed (currently used for forced cool down). It should also be understood that the application of these methods is advantageous to many operational and maintenance needs of the gas turbine equipment that require shutdowns, cooldowns, startups and heatups and is not restricted to a water wash cycle. While various embodiments are described herein, it will be appreciated from the specification that various combinations of elements, variations or improvements therein may be made, and are within the scope of the invention.

1. A method for performing an outage of a gas turbine including a compressor and a turbine, wherein the gas turbine is cooled down to a maintenance condition, the method comprising:
holding the gas turbine at full speed-no load (FSNL) conditions during a shutdown to relieve thermal stresses in a most limiting component of the gas turbine at FSNL conditions.

2. The method according to claim 1, the step of holding the gas turbine at FSNL during a shutdown further comprising:
holding at FSNL conditions for a designated time.

3. The method according to claim 2, wherein holding the gas turbine at full speed-no load (FSNL) conditions for the designated time does not cause a non-limiting component at FSNL conditions for the gas turbine to become more limiting than the most limiting component at FSNL conditions due to thermal stresses of holding the gas turbine at FSNL conditions for the designated time.

4. The method according to claim 3, wherein the most limiting component whose lifetime is improved by holding at FSNL conditions is a compressor rotor and a non-limiting component whose lifetime is reduced is a turbine rotor.

5. The method according to claim 1, further comprising:
performing a forced cooldown by circulating ambient air through the hot gas path of the gas turbine according to a speed of the gas turbine;
controlling acceleration of the gas turbine to a first cooldown speed and a second cooldown speed during a forced cooldown to a temperature suitable for conducting a maintenance operation;
performing a partial turbine cooldown at a first cooldown speed;
completing the turbine cooldown at a second cooldown speed, wherein the second cooldown speed is greater than the first cooldown speed.

6. The method according to claim 5, further comprising:
a slow soak acceleration of the gas turbine from a ratchet speed to the first cooldown speed; and
a slow soak acceleration of the gas turbine from the first cooldown speed to the second cooldown speed.

7. The method according to claim 5, wherein limiting the first cooldown speed and the second cooldown speed restrict thermal shock on the most limiting gas turbine component during the cooldown.

8. The method according to claim 6, wherein the most limiting gas turbine component during the turbine cooldown comprises a turbine rotor.

9. The method according to claim 1, further comprising:
ramping up gas turbine speed during a startup at a reduced rate relative to a normal ramp rate during startup.

10. The method according to claim 9, the step of ramping at a reduced rate further comprising:
ramping up gas turbine speed at a reduced rate when the gas turbine is operating between about 30% to about 55% of FSNL.

11. The method according to claim 10 wherein the step of ramping up gas turbine speed when the gas turbine is operating between about 30% to 55% of FSNL limits compressive stress.

12. The method according to claim 9, further comprising:
holding the gas turbine at FSNL conditions prior to loading.

13. The method according to claim 12, the step of holding the gas turbine at FSNL conditions prior to loading comprising:
holding the gas turbine at FSNL conditions for a predetermined time prior to loading.

14. The method according to claim 12, wherein the step of holding the gas turbine at FSNL conditions prior to loading limits stress on a compressor wheel.

15. A method for performing an outage of a gas turbine including a compressor and a turbine to a cooled down condition for a maintenance operation, the method comprising:
holding the gas turbine at full speed-no load conditions during a shutdown;
controlling acceleration of the gas turbine to a first cooldown speed and a second cooldown speed during a forced cooldown to a temperature suitable for conducting a wash operation of the hot gas path;
performing a partial turbine cooldown at a first cooldown speed; and
completing the turbine cooldown at a second cooldown speed, wherein the second cooldown speed is greater than the first cooldown speed.

16. The method according claim 15, the step of holding further comprising:
holding the gas turbine at full speed-no load (FSNL) conditions for a predetermined time during a shutdown for relieving thermal stresses in a most limiting component of the gas turbine at FSNL conditions.

17. The method according to claim 16, the step of controlling acceleration comprising:
a slow soak acceleration of the gas turbine from a ratchet speed to the first cooldown speed; and
a slow soak acceleration of the gas turbine from the first cooldown speed to the second cooldown speed.

18. A method for restoring from an outage of a gas turbine including a compressor and a turbine in a cooled down condition for a maintenance, the method comprising:
ramping gas turbine speed at a reduced rate during acceleration to full speed-no load conditions; and
holding the gas turbine at full speed-no load conditions prior to loading the turbine.

19. The method according to claim 18, the step of ramping comprising:
ramping up gas turbine speed at a reduced rate when the gas turbine is operating between about 30% to about 55% of FSNL.

20. The method according to claim 19, the step of holding comprising:
holding the gas turbine at FSNL conditions for a predetermined time prior to loading.
